(19) United States
(12) Patent Application Publication
(10) Pub. No.: US 2012/0233210 A1
(43) Pub. Date: Sep. 13, 2012

(54) Storage of Arbitrary Points in N-Space and Retrieval of Subset thereof Based on Criteria Including Maximum Distance to an Arbitrary Reference Point

(76) Inventor: Matthew Thomas Bogosian, Marina, CA (US)

(21) Appl. No.: 13/046,740

(22) Filed: Mar. 12, 2011

(51) Int. Cl. G06F 17/30

(52) U.S. Cl. 707/770; 707/E17.014

(57) ABSTRACT

Provided are: 1) storage in a data store of points of interest in n-space along with arbitrary related information; and 2) efficient retrieval of subsets of those points meeting arbitrary criteria. Criteria can limit retrieval to neighbors of a reference point (i.e., points that are within a specified distance of that reference point). The method may be used to retrieve subsets from data stores which limit inequality or range operations. When used to model neighboring points on a planetary surface in 3-space, the method does not suffer from polar distortion (where spherical coordinate systems have difficulty).

This application claims the benefit of U.S. Provisional Application No. 61/313,733, filed Mar. 13, 2010, the disclosure of which is hereby incorporated by reference.

### BACKGROUND OF THE INVENTION

The present invention relates to the storage and retrieval of arbitrary points in n-space in and from a data store and methods for implementing and using such an invention. More specifically, the invention relates to the computationally efficient retrieval of a subset of points in a data store that are within a specified distance of an arbitrary reference point that is not known at the time of storage. In addition the invention allows for arbitrary data to be stored with each point in a data store, and allows retrieval criteria to be specified for that data as well.

Efficiently searching through large data sets remains an important part of displaying relevant and targeted content to consumers of that data. Consumers demand and expect such targeted content to be readily available.

The importance of geo location data has grown with its pervasiveness. An increasing number of today's mobile products can “know where they are” either via satellite or signal triangulation. Such features are rapidly becoming standard in today's consumer communication devices. These devices are becoming more sophisticated in their abilities to produce content (e.g., images, video) as well as display it. The number of consumers of those devices is increasing as well.

Encoded in much consumer-produced content is the geo location data of the device at the time the content was created. This geo location data can be used to identify the content with a location. For example, a digital photograph contains not only the image itself, but may also contain the date, time and location of creation.

The ability to store vast libraries of digital content currently exists. However, consumers demand increasingly complex views into that content. For example, a consumer with a mobile device may want to publish a photograph taken in a location. Another consumer may want to compare that photograph with other published photographs taken near that same location.

Despite the increasing sophistication of applications and services making use of this content, the ability to efficiently identify and retrieve such subsets is limited. Existing methods are computationally expensive and unsophisticated and are hence ill-equipped to meet the projected demand.

Accordingly, it would be desirable to have innovative mechanisms that allow for not only the storage and retrieval of such content, but that would also allow efficient retrieval of subsets based on criteria relevant to the location of that content and/or the consumer of that content.

### SUMMARY OF THE INVENTION

The present invention provides innovative mechanisms to allow the storage of arbitrary data associated with arbitrary points in n-space (primary points) and to allow the retrieval of subsets of that data matching arbitrary criteria which could include those whose associated points are within a specified distance of an arbitrary point unknown at the time of storage. The mechanisms provide for a predictable calculation to associate set(s) of points (secondary points) with each point. A set of secondary points may define a shape which encloses the primary point (e.g., triangle, square, hexagon, tetrahedron, cube, combinations thereof, etc.). Shapes could share vertices with neighboring shapes. The sets of points defining the vertices of these enclosing shapes may be referred to as “canonical sets” or sets of “canonical points”. If a canonical point is encoded as a single number, it may be referred to as a “canonical number”. Primary points which share one or more canonical points in a specific set are considered near each other (i.e., within the specified distance, or within the same or neighboring enclosing shape), whereas those which don't are not.

By allowing nearness comparisons to be based on intersection of common values, the mechanisms provide a vastly more efficient means of retrieval than traditional methods because comparisons are direct or equality-based rather than range- or inequality-based.

In one embodiment, the invention provides a method for a user to store points in n-space and related data where the set(s) of canonical points are computed automatically from the points stored. An administrative user defines a schema indicating what (if any) data is to be associated with each point, which could include required data, optional data, or could permit storage of arbitrary data not defined within the schema. The administrative user also defines the method of computing the canonical points to be associated with each point. When a storing user submits a point and associated data for storage, the data is verified against the schema, the canonical points are calculated from the submitted point (and optionally any associated data), and the point, submitted data and canonical points are all stored as a record (or set of associated records) in the data store.

In another embodiment, the invention provides a method for a user to specify criteria defining a subset of all stored points and to retrieve that subset of points and associated data. A retrieving user submits criteria specifying zero or more limits on the points' associated data along with zero or more arbitrary points that the retrieved points must be “near”. Canonical points are calculated for each arbitrary point using the same calculation as in the storage embodiment (above). Points in the data store that share one or more canonical points with those generated from the arbitrary points and which meet any other specified criteria are transmitted to the retrieving user along with any data associated with those points.

In another embodiment, the invention provides a method for storage and retrieval of points in 3-space which exist on the surface of a solid approximating a spherical object (like a planet). The spherical object is approximated by a non spherical surface made up of discrete faces (e.g., a Platonic solid or subdivision or tessellation thereof) as determined by an administrative user. During storage, the enclosing face on the solid is computed for the point submitted by a storing user. The canonical numbers stored with that point are computed as encoded representations of the vertices of that face. During retrieval, the same calculation is applied to any arbitrary point(s) submitted by a retrieving user. Points retrieved will share one or more vertices with any arbitrary point(s) submitted.

In another embodiment, the invention provides a method for storage and retrieval of points in n-space based on shapes whose edges are all equal in length (e.g., line segment, square, cube, hypercube, etc.), the magnitude of which is determined by an administrative user. During storage, the enclosing shape is computed for the point submitted by a storing user. The canonical numbers stored with that point are computed as encoded representations of the vertices of that shape. During retrieval, the same calculation is applied to any arbitrary point(s) submitted by a retrieving user. Points retrieved will share one or more vertices with any arbitrary point(s) submitted.

In another embodiment, the invention provides a method for storing an arbitrary number of canonical sets with each point. Each canonical set may represent a single distance and a single calculation model. Multiple canonical sets allows for multiple enclosing shapes (i.e., multiple distances [e.g., one set for 1 m, one for 10 m, 100 m, 1 km, etc.] and multiple calculation models) to be associated with each point in the data store simultaneously. The number and definitions of each canonical set to be stored with each point is defined by an administrative user. During storage, multiple enclosing shapes are computed for the point submitted by a storing user. Multiple sets of canonical points are stored with that point, each set corresponding to one enclosing shape. During retrieval, a retrieving user specifies which canonical set(s) should be used for comparison with any arbitrary point(s) submitted by the retrieving user. Points retrieved will share one or more vertices with the arbitrary point(s) submitted.

With the embodiments, any number of canonical sets may be stored with each point along with any other arbitrary data. This allows for the retrieval of “near” points within any distance specified by an administrative user. Multiple sets can exist simultaneously, so the same data store may be used to retrieve points within as many different distances as sets without significantly affecting efficiency. Additional sets may be computed and stored at any time, since they are based on data present in the data store. This would allow an administrative user to create a schema defining two sets (e.g., one representing 1 km, and one 100 km). Assuming storing users populated the data store with many points, an administrative user could later decide to add a third set (e.g., 10 km). The third set would be computed for each point in the data store and stored with that point. From then on points submitted by storing users would acquire all three sets, and retrieving users would be able to use the third set in their subset criteria.

### BRIEF DESCRIPTION OF THE DRAWINGS

FIG. 1 shows a block diagram of an embodiment within the context of a network.

FIG. 2. shows a block diagram of an embodiment of the storage of points in a data store.

FIG. 3 shows a block diagram of components that may be present in devices and computer systems that implement the invention.

FIG. 4 shows a flowchart of a process to retrieve points from the data store that match arbitrary criteria.

FIG. 5 shows a flowchart of a process to store new points in the data store.

### DETAILED DESCRIPTION OF THE PREFERRED EMBODIMENT

In the description that follows, the present invention will be described in reference to embodiments that allow for the storage and retrieval of arbitrary points in n-space in and from a data store. More specifically, the embodiments will be described in reference to preferred embodiments. However, embodiments of the invention are not limited to any particular configuration, architecture, or specific implementation. Therefore, the description of the embodiments that follows is for purposes of illustration and not limitation.

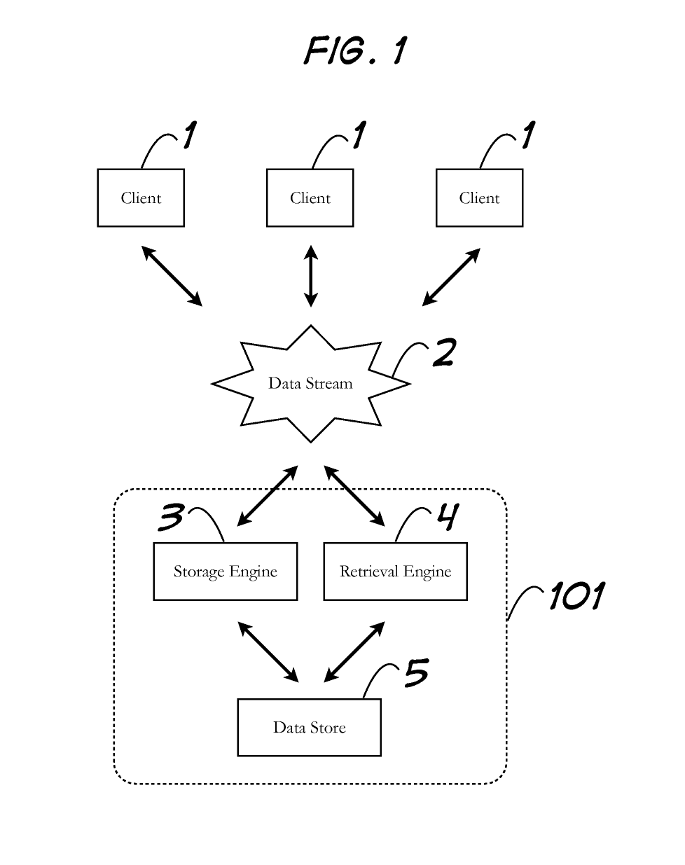

FIG. 1 shows a block diagram of an embodiment within the context of a network. Client 1 interacts through a data stream 2 with a server 101. The Data stream 2, like all network representations shown herein, can be any network media that allows network devices to communicate.

Server 101 consists of a storage engine 3 and a retrieval engine 4. Storage engine 3 and retrieval engine 4 may be independent components, or they may exist as part of a larger component (e.g., one that is exposed through a single Application Programmer's Interface [API]).

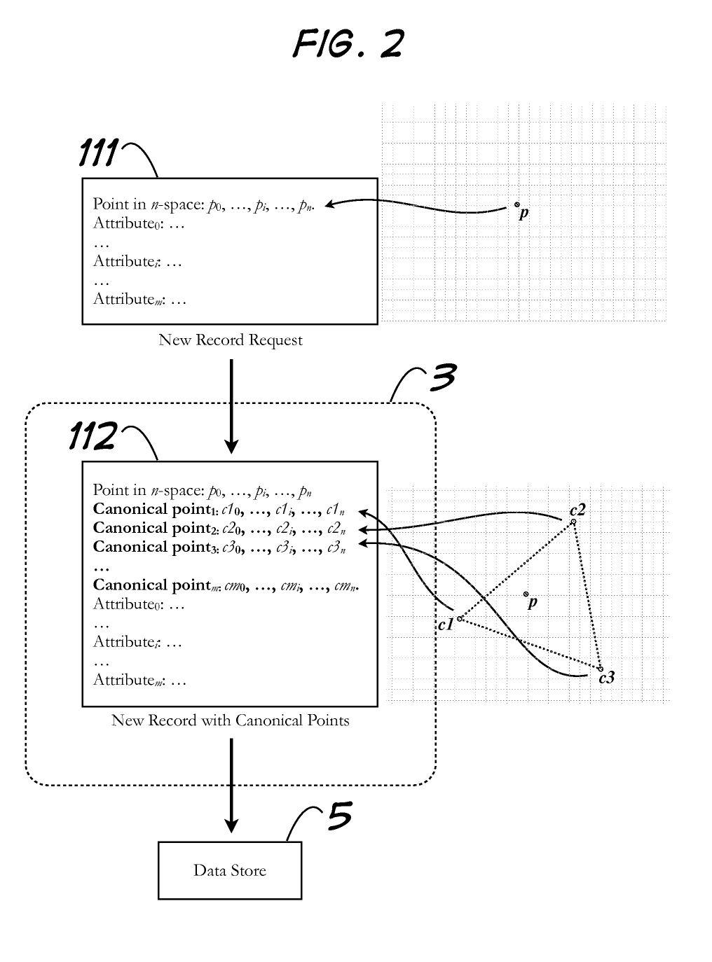

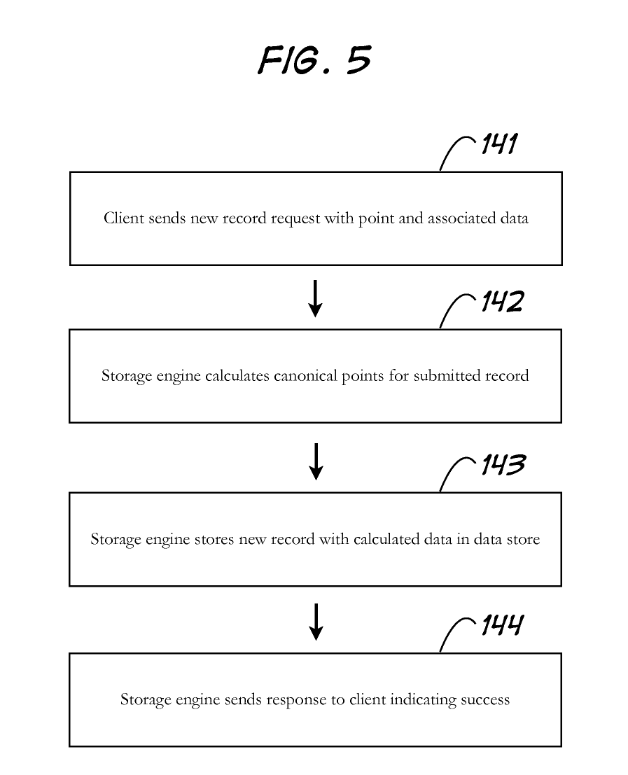

Storage engine 3 interacts with data store 5 to store an arbitrary set of points in n-space along with arbitrary data associated with each of those points as well as any calculated canonical points to be used by the retrieval engine. This process is illustrated in more detail in FIGS. 2 and 5.

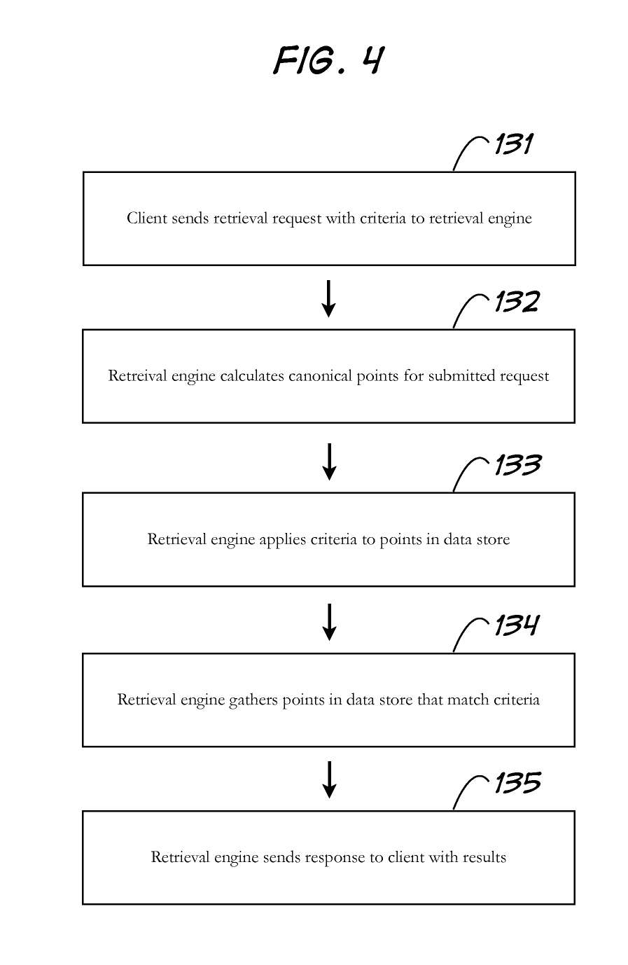

Retrieval engine 4 receives arbitrary matching criteria from client 1. Retrieval engine 4 interacts with data store 5 to perform queries which match points stored in data store 5 against the arbitrary criteria received from client 1. Retrieval engine 4 retrieves data associated with any matched points from data store 5 and sends the subset of matched points and corresponding data to client 1. This process is illustrated in more detail in FIG. 4.

FIG. 2. shows a block diagram of an embodiment of the storage of points in a data store. Client sends new record request 111 consisting of a point in n-space and any corresponding data to storage engine 3. Storage engine 3 calculates any canonical points associated with the point in n-space submitted as part of new record request 111. Storage engine 3 merges new record request 111 and the calculated canonical points into new record with canonical points 112. Storage engine 3 submits new record with canonical points 112 to data store 5 for storage and later retrieval. Retrieval is illustrated in more detail in FIG. 4.

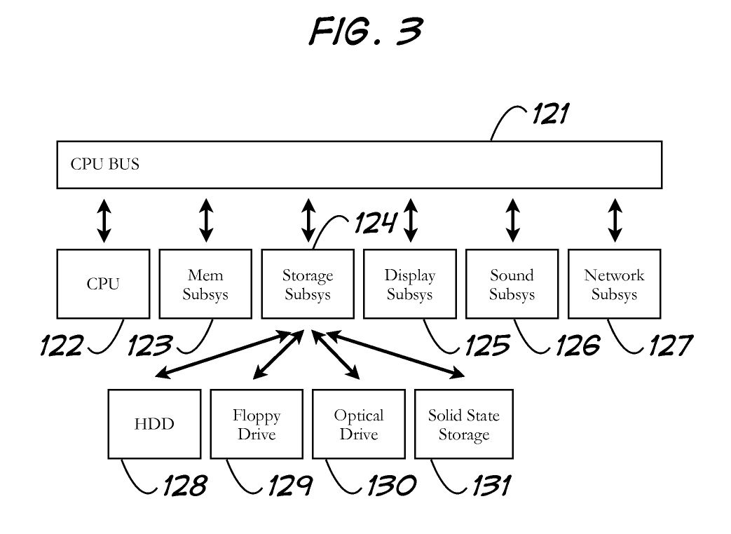

FIG. 3 shows a block diagram of components that may be present in devices and computer systems that implement the invention. Additional or fewer components may exist in any individual device. Nevertheless, FIG. 3 is fairly representative.

A central processing unit (CPU) bus 121 allows the various components of the computing device to communicate. A CPU 122 executes instructions or computer code which can be stored in a memory subsystem 123. Memory subsystem 123 represents what is typically volatile memory.

A display subsystem 125 is responsible for displaying information, images or text to users. A sound subsystem 126 is responsible for generating sound and may include one or more speakers. A network subsystem 127 allows that computing device or computer system to communicate over a network.

A storage subsystem 124 is responsible for nonvolatile storage of computer code and data. Representative storage media include a hard drive 128, a floppy drive 129, an optical (e.g., CD-, DVD-ROM, etc.) drive 130, or a solid state storage 131.

The storage and retrieval mechanisms can be accessible via to clients via a data stream like local shared memory, a proprietary network, or the Internet and can be made available using modern remote procedure call protocols (e.g., REST, SOAP, XML-RPC, proprietary protocols, etc.). Support for additional protocols can be added according to developer demand.

Moving from a description of representative hardware and interfaces, FIG. 4 shows a flowchart of a process to retrieve points from the data store that match arbitrary criteria. As with all flowcharts shown herein, steps can be added, deleted, combined, and reordered without departing from the spirit and scope of the invention.

At step 131, a request is made from the client to the retrieval engine. The request includes matching criteria. The matching criteria could include a point in n-space.

At step 132, the retrieval engine calculates the canonical points for any point (s) submitted with the matching criteria in step 131.

At step 133, the retrieval engine retrieves all points from the data store which match the criteria and share any canonical point with the canonical points calculated in step 132.

In alternate embodiments, more complex canonical point and other criteria matching may be described in the request by the client using boolean logic and other operators (e.g., comparative operators like ≦ and >, string matching operators like “begins-with” or “contains”). This is not an exhaustive list. It is merely illustrative of providing the ability to express complex queries using arbitrary expressions.

At step 134, the retrieval engine gathers all data associated with the zero-or-more points found in step 133.

At step 135, the list of points and corresponding data retrieved in steps 133 and 134 are sent to the client.

In alternative embodiments, clients may specify schema definitions along with matching criteria to narrow the amount of data retrieved in step 134 and returned in step 135 so that not all corresponding data is sent to the client. This could be in the form of a limit on the number of points returned, ordering specifications, or an inclusionary or exclusionary list of the types, names, etc. of any corresponding data to either return or omit.

FIG. 5 shows a flowchart of a process to store new points in the data store.

At step 141, a new record request is made from the client. The new record request contains an arbitrary point in n-space and an arbitrary set of data associated with that point.

At step 142, the storage engine calculates the canonical points for the point submitted as part of the new record request.

At step 143, the storage engine stores the new record submitted in step 141 along with the canonical points calculated in step 142 in the data store.

At step 144, the storage engine (optionally) sends a response to the client indicating to success.

What is claimed is:

1. A method of identifying a set of points in n-space comprising: storing points and information relating to those points as records in a persistent data store; and retrieving subsets of points stored and any related information from that data store based on zero or more matching criteria.

2. A method of claim 1 where a record stored in the data store represents a single point (the primary point) in a normalized coordinate system.

3. A method of claim 2 where the coordinate system used is a cartesian coordinate system.

4. (canceled)

5. (canceled)

6. (canceled)

7. (canceled)

8. (canceled)

9. (canceled)

10. (canceled)

11. A method of claim 2 where records stored in the data store represent points in n-dimensional space.

12. A method of claim 2 where the values defining the points within the coordinate system may be represented as coordinate vectors.

13. A method of claim 12 where all values in a coordinate vector may be encoded as a single value.

14. A method of claim 13 where the encoded value may be a Morton number.

15. A method of claim 1 where additional arbitrary data may be associated with each record.

16. A method of claim 15 where the additional data may be a timestamp.

17. (canceled)

18. (canceled)

19. (canceled)

20. (canceled)

21. (canceled)

22. (canceled)

23. A method of claim 15 where the additional data may be a reference to a user identity, identification number or account.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A method of claim 15 where the additional data may be references to other points (secondary points).

38. A method of claim 37 where the secondary points may be represented as coordinate vectors.

39. A method of claim 38 where all values in a coordinate vector may be encoded as a single value.

40. A method of claim 39 where the encoded value may be a Morton number.

41. A method of claim 37 where the secondary points may define one or more shapes.

42. A method of claim 41 where the shapes defined each enclose the primary point associated with that record.

43. A method of claim 42 where the shapes are the result of a calculation based on other data associated with that record.

44. A method of claim 43 where the other data includes the primary point associated with that record.

45. A method of claim 44 where the primary point exists on the surface of one or more solids, and the calculation defines the secondary points as the faces on those solids that enclose the primary point.

46. (canceled)

47. (canceled)

48. A method of claim 45 where the solid is a Platonic solid or tessellation thereof.

49. (canceled)

50. A method of claim 45 where the faces of the solid have one or more subdivisions.

51. (canceled)

52. (canceled)

53. (canceled)

54. (canceled)

55. (canceled)

56. A method of claim 50 where the calculation for determining the enclosing faces uses quantized barycentric triangulation.

57. A method of claim 44 where the calculation for determining the enclosing shapes uses n-space quantization.

58. (canceled)

59. (canceled)

60. A method of claim 1 where retrieval of records from the data store may be based on arbitrary criteria.

61. A method of claim 60 where the arbitrary criteria could include one or more arbitrary points in n-space (primary points).

62. A method of claim 61 where the primary points may be represented as coordinate vectors.

63. A method of claim 62 where all values in a coordinate vector may be encoded as a single value.

64. A method of claim 63 where the encoded value may be a Morton number.

65. A method of claim 60 where additional criteria may be calculated from the arbitrary criteria.

66. A method of claim 61 where additional criteria may be calculated from the primary points.

67. A method of claim 66 where the additional criteria may be references to other points (secondary points).

68. A method of claim 67 where the secondary points may be represented as coordinate vectors.

69. A method of claim 68 where all values in a coordinate vector may be encoded as a single value.

70. A method of claim 69 where the encoded value may be a Morton number.

71. A method of claim 67 where the secondary points may define one or more shapes.

72. A method of claim 71 where the shapes defined each enclose a primary point included in the criteria.

73. A method of claim 72 where the shapes are the result of a calculation based on other data included in the criteria.

74. A method of claim 73 where the other data includes a primary point included in the criteria.

75. A method of claim 74 where the primary point exists on the surface of one or more solids, and the calculation defines the secondary points as the faces on those solids that enclose the primary point.

76. (canceled)

77. (canceled)

78. A method of claim 75 where the solid is a Platonic solid or tessellation thereof.

79. (canceled)

80. A method of claim 75 where the faces of the solid have one or more subdivisions.

81. (canceled)

82. (canceled)

83. (canceled)

84. (canceled)

85. (canceled)

86. A method of claim 80 where the calculation for determining the enclosing faces uses quantized barycentric triangulation.

87. A method of claim 74 where the calculation for determining the enclosing shapes uses n-space quantization.

88. (canceled)

89. (canceled)

90. A method of claim 67 where the criteria may require a comparison of the calculated secondary points and the secondary points associated with each point stored in the data store.

91. A method of claim 90 where the criteria may specify the intersection of one or more calculated secondary points with one or more secondary points associated with each point stored in the data store.

92. A method of claim 91 where the criteria may include the cardinality of the of intersection.

93. (canceled)

94. (canceled)

95. A method of claim 92 where the cardinality may be used to limit or sort any points retrieved from in the data store.

96. A method of claim 1 where points are interpreted or calculated from the metadata of digital media.

97. (canceled)

98. (canceled)

99. A method of claim 96 where the digital media is harvested from a website hosting such digital media.

100. (canceled)

101. (canceled)

102. (canceled)

103. (canceled)

104. (canceled)

105. (canceled)

106. (canceled)

107. (canceled)

108. (canceled)

109. (canceled)

110. A method of claim 15 where the additional data may be a reference to a digital resource outside of the invention.

111. A method of claim 110 where the reference may be a URI.

112. (canceled)

113. (canceled)

114. (canceled)

115. (canceled)

116. (canceled)
